(19) United States
(12) Patent Application Publication
(10) Pub. No.: US 2026/0125091 A1
(43) Pub. Date: May 7, 2026

(54) SINGLE-SIDE OPEN FOLDABLE CART FRAME

(71) Applicant: Lingai XIA, Ningbo (CN)

(72) Inventor: Lingai XIA, Ningbo (CN)

(21) Appl. No.: 19/437,373

(22) Filed: Dec. 31, 2025

Related U.S. Application Data
(63) Continuation of application No. PCT/CN2024/117297, filed on Sep. 6, 2024.

(30) Foreign Application Priority Data
Jul. 19, 2023 (CN) 202310886112.0

(51) Int. Cl. B62B 3/02; A47B 13/08; B62B 5/06

(52) U.S. Cl. CPC B62B 3/02; A47B 13/08; B62B 5/06; B62B 2205/06; B62B 2205/20

(57) ABSTRACT

The provided is a single-side open foldable cart frame, including a front frame, a rear frame, a single-side frame and a bottom frame. The front frame and the rear frame are respectively connected to front and rear sides of the bottom frame. Front and rear sides of the single-side frame are respectively connected to a left side of the front frame and a left side of the rear frame. Both the bottom frame and the single-side frame are foldable structures that are interconnected. A limit mechanism for keeping the foldable cart frame in an unfolded state when the foldable cart frame is unfolded is provided on the bottom frame. By only setting a single-side frame, the foldable cart can not only receive items but also accommodate people. People can sit on the open side of the foldable cart and lean against the single-side frame, which improves the comfort and safety.

### CROSS-REFERENCE TO THE RELATED APPLICATIONS

This application is a continuation application of International Application No. PCT/CN2024/117297, filed on Sep. 6, 2024, which is based upon and claims priority to Chinese Patent Application No. 202310886112.0, filed on Jul. 19, 2023, the entire contents of which are incorporated herein by reference.

### TECHNICAL FIELD

The present invention relates to the technical field of foldable carts, specifically to a single-side open foldable cart frame.

### BACKGROUND

At present, the overall frames of foldable carts are mainly divided into two types. The first type is the design where all four sides are enclosed or semi-enclosed, such as the carts disclosed in Chinese patents CN209700727U and CN207416897U. The second type is the design where both sides are open while the front and rear are enclosed or semi-enclosed, such as the cart disclosed in Chinese patent CN215284881U. In the first type, since the frame is enclosed on all four sides, it cannot realize the function of allowing people to sit on the side. Moreover, when the tabletop is laid flat on the cart, since the frame is enclosed on all four sides, a user has to take off the tabletop first in order to acquire the items inside the cart, which is very inconvenient to operate. In the second type, people can sit on it, but both sides of the frame in this type are open, so when a person sits on one side, the frame on the side where the people's back is located is open, and thus cannot provide support for the people's back, resulting in low comfort. At the same time, there is also a potential safety hazard of people falling backward.

### SUMMARY

In view of the shortcomings of the prior art, an objective of the present invention is to provide a single-side open foldable cart frame, in order to address the technical problem in the prior art that the foldable cart cannot ensure the comfort and safety of people sitting as well as the convenience of taking out items.

To address the technical problem above, the present invention provides a single-side open foldable cart frame, including a front frame, a rear frame, a single-side frame and a bottom frame. The front frame and the rear frame are respectively connected to front and rear sides of the bottom frame. Front and rear sides of the single-side frame are respectively connected to a left side of the front frame and a left side of the rear frame. Both the bottom frame and the single-side frame are foldable structures that are interconnected. A limit mechanism for keeping the foldable cart frame in an unfolded state when the foldable cart frame is unfolded is provided on the bottom frame.

By adopting the above structure, the single-side open foldable cart frame provided by the present invention has the following advantages: By only setting a single-side frame, the foldable cart can not only receive items but also accommodate people. People can sit on the open side of the foldable cart and lean against the single-side frame, which improves the comfort and safety when they sit. Moreover, even after the tabletop board is placed on the front frame and the rear frame, it is still possible to take items from the open side of the foldable cart, which is convenient to use.

As an improvement, the bottom frame includes a first frame and a second frame. One end of the first frame is hinged to a bottom end of the front frame, the other end of the first frame is hinged to one end of the second frame, and the other end of the second frame is hinged to a bottom end of the rear frame. The limit mechanism includes a stop strip provided on the other end of the first frame. When the foldable cart frame is in the unfolded state, the stop strip abuts against an upper side of the one end of the second frame, such that the one end of the second frame and the other end of the first frame cannot rotate downward. When folding is required, the other end of the first frame and the one end of the second frame rotate upward. By adopting this structure, during folding, the hinged position of the first frame and the second frame is lifted upward, and the first frame and the second frame approach each other and are folded, showing the convenience of folding operation.

As an improvement, the single-side frame includes a plurality of first scissor-type hinge components. The plurality of first scissor-type hinge components are hinged to each other successively from front to back. An upper end of the first scissor-type hinge component located at a foremost side is hinged to the front frame, and a lower end of the first scissor-type hinge component located at the foremost side is hinged to a first slider slidably connected to the front frame. An upper end of the first scissor-type hinge component located at a rearmost side is hinged to the rear frame, and a lower end of the first scissor-type hinge component located at the rearmost side is hinged to a second slider slidably connected to the rear frame.

As an improvement, the upper end of the first scissor-type hinge component located at the foremost side and the upper end of the first scissor-type hinge component located at the rearmost side respectively form first bending sections, and the first bending sections are respectively hinged to an upper right side of the front frame and an upper right side of the rear frame. By adopting this structure, since one side of the entire cart frame is designed to be open without rigid support, when the upper end of the right opening part of the front frame or rear frame is subjected to a force outward along the cart, such as transporting too many items or people sitting on the bottom frame and holding the upper end of the right opening part of the front frame or rear frame with their palm, it is easy to damage the front frame or rear frame. In view of this, the first bending sections are respectively provided at the upper end of the first scissor-type hinge component at the foremost side and the upper end of the first scissor-type hinge component at the rearmost side, and are respectively hinged to the upper right side of the front frame and the upper right side of the rear frame, which can better reinforce the front frame and the rear frame.

As an improvement, the bottom frame includes a connecting block and four first connecting rods. A projection of the connecting block on a horizontal plane falls at a center of the bottom frame. One end of each of the four first connecting rods is hinged to the connecting block, and the other ends of the four first connecting rods are obliquely arranged and respectively hinged to left and right sides of a bottom end of the front frame and left and right sides of a bottom end of the rear frame. Both the front frame and the rear frame are foldable structures that are foldable along a left-right direction. The limit mechanism includes a baffle connected to an upper end surface of the connecting block. When the foldable cart frame is in the unfolded state, an upper end surface of the one end of each first connecting rod abuts against the baffle, such that the one end of each first connecting rod cannot rotate downward. When folding is required, the one end of each first connecting rod rotates upward. By adopting this structure, the bottom frame, the single-side frame, the front frame and the rear frame have foldable structures, which makes the left and right widths of the cart after being folded are smaller and the structure is more compact.

As an improvement, the front frame includes two first uprights and a plurality of second scissor-type hinge components. The plurality of second scissor-type hinge components are hinged to each other successively from left to right. An upper end of the second scissor-type hinge component located at a leftmost side is hinged to the first upright on left, and a lower end of the second scissor-type hinge component located at the leftmost side is hinged to a first slider slidably connected to the first upright on the left. An upper end of the second scissor-type hinge component located at a rightmost side is hinged to the first upright on right, and a lower end of the second scissor-type hinge component located at the rightmost side is hinged to a third slider slidably connected to the first upright on the right. The rear frame includes two second uprights and a plurality of third scissor-type hinge components. The plurality of third scissor-type hinge components are hinged to each other successively from left to right. An upper end of the third scissor-type hinge component located at the leftmost side is hinged to the second upright on the left, and a lower end of the third scissor-type hinge component located at the leftmost side is hinged to a second slider slidably connected to the second upright on the left. An upper end of the third scissor-type hinge component located at the rightmost side is hinged to the second upright on the right, and a lower end of the third scissor-type hinge component located at the rightmost side is hinged to a fourth slider slidably connected to the second upright on the right.

As an improvement, the single-side frame includes two second connecting rods and two third connecting rods. The two second connecting rods are crossed and hinged to each other. One end of one of the third connecting rods is hinged to the upper end, adjacent to the front frame, of the second connecting rod among the two second connecting rods, and the other end of the one of the third connecting rods is hinged to the front frame. One end of the other third connecting rod is hinged to the upper end, adjacent to the rear frame, of the second connecting rod among the two second connecting rods, and the other end of the other third connecting rod is hinged to the rear frame.

As an improvement, the other ends of the two third connecting rods respectively bend and extend rightward to form second bending sections, and the second bending sections are respectively hinged to an upper right end of the front frame and an upper right end of the rear frame. By adopting this structure, since one side of the entire cart frame is designed to be open without rigid support, when the upper end of the right opening part of the front frame or rear frame is subjected to a force outward along the cart, such as transporting too many items or people sitting on the bottom frame and holding the upper end of the right opening part of the front frame or rear frame with their palm, it is easy to damage the front frame or rear frame. In view of this, the second bending sections are respectively provided at the other ends of the two third connecting rods, and are respectively hinged to the upper right end of the front frame and the upper right end of the rear frame, which can better reinforce the front frame and the rear frame.

As an improvement, the present invention further includes a tabletop board placed on the front frame and the rear frame. By adopting this structure, it is convenient to place items on the tabletop board. When the tabletop board is placed, it is still possible to take items from the open side of the foldable cart, which is convenient to use.

As an improvement, the front frame is connected to a push-pull rod, and the push-pull rod is hinged to the front frame. Wheels are connected to bottom ends of both the front frame and the rear frame. By adopting this structure, it is convenient to move the cart and requires less effort when moving.

### BRIEF DESCRIPTION OF THE DRAWINGS

FIG. 1 is a perspective diagram showing an overall structure when a tabletop board is not placed in Embodiment 1 of the present invention.

FIG. 2 is a perspective diagram showing an overall structure when the tabletop board is placed in Embodiment 1 of the present invention.

FIG. 3 is a perspective diagram showing an overall structure when folded in Embodiment 1 of the present invention.

FIG. 4 is a perspective diagram showing an overall structure in Embodiment 2 of the present invention.

FIG. 5 is a perspective diagram showing an overall structure when folded in Embodiment 2 of the present invention.

FIG. 6 is a perspective diagram showing an overall structure in Embodiment 3 of the present invention.

FIG. 7 is a perspective diagram showing an overall structure when folded in Embodiment 3 of the present invention.

Reference numerals: 100, front frame; 200, rear frame; 300, single-side frame; 400, bottom frame; 500, push-pull rod; 600, wheels; 700, tabletop board; 1, first frame; 2, second frame; 3, first scissor-type hinge component; 31, first bending section; 4, first slider; 5, second slider; 6, connecting block; 7, first connecting rod; 8, first upright; 9, second scissor-type hinge component; 10, third slider; 11, second upright; 12, third scissor-type hinge component; 13, fourth slider; 14, second connecting rod; 15, third connecting rod; 151, second bending section; 16, stop strip; and 17, baffle.

### DETAILED DESCRIPTION OF THE EMBODIMENTS

A single-side open foldable cart frame of the present invention is described in detail below in conjunction with the drawings.

### Embodiment 1

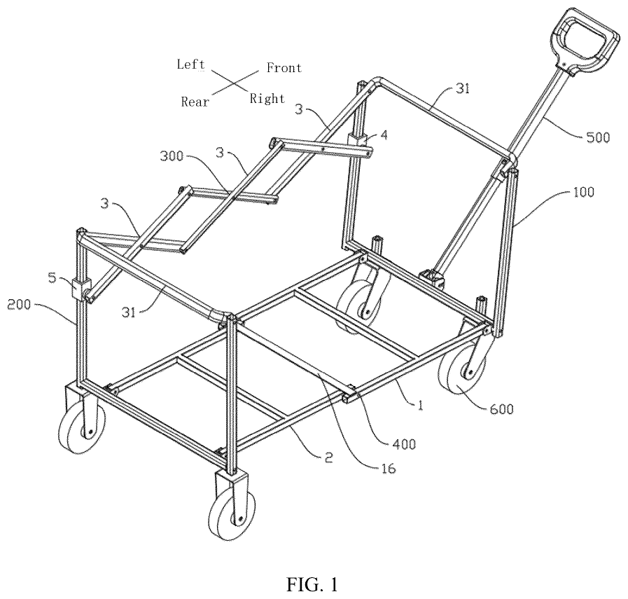

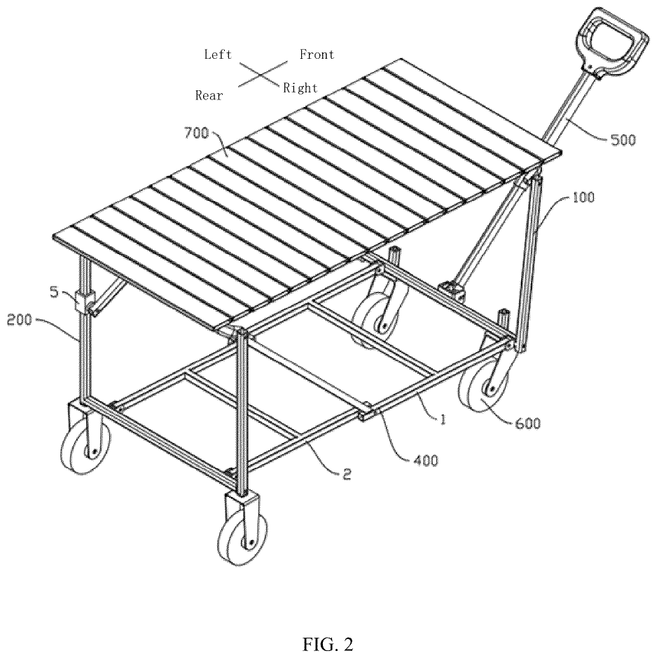

As shown in FIGS. 1 to 3, in this embodiment, a single-side open foldable cart frame includes the front frame 100, the rear frame 200, the single-side frame 300 and the bottom frame 400. The front frame 100 and the rear frame 200 are respectively connected to the front and rear sides of the bottom frame 400. The front and rear sides of the single-side frame 300 are respectively connected to the left side of the front frame 100 and the left side of the rear frame 200. The front frame 100 is connected to the push-pull rod 500, and the lower end of the push-pull rod 500 is hinged to the bottom end of the front frame 100. Both the bottom frame 400 and the single-side frame 300 are foldable structures that are interconnected and foldable along the front-rear direction. Specifically, the bottom frame 400 is foldable along the front-rear direction, and the single-side frame 300 is also foldable along the front-rear direction. The wheels 600 are connected to the bottom ends of both the front frame 100 and the rear frame 200. In this embodiment, there are a total of four wheels 600 and they are distributed at the four corners. A limit mechanism for keeping the foldable cart frame in an unfolded state when it is unfolded is provided on the bottom frame 400.

As shown in FIG. 1, the bottom frame 400 includes the first frame 1 and the second frame 2. One end of the first frame 1 is hinged to the bottom end of the front frame 100, the other end of the first frame 1 is hinged to one end of the second frame 2, and the other end of the second frame 2 is hinged to the bottom end of the rear frame 200. Their axis directions during rotation are all along the left-right direction. The limit mechanism includes a stop strip 16 provided on the other end of the first frame 1. When the foldable cart frame is in an unfolded state, the stop strip 16 abuts against the upper side of one end of the second frame 2, such that one end of the second frame 2 and the other end of the first frame 1 cannot rotate downward. When folding is required, the other end of the first frame 1 and one end of the second frame 2 rotate upward.

As shown in FIG. 1, the single-side frame 300 includes a plurality of first scissor-type hinge components 3. The plurality of first scissor-type hinge components 3 are hinged to each other successively from front to back. In this embodiment, there are three first scissor-type hinge components 3. The middle first scissor-type hinge component 3 is hinged with the first scissor-type hinge components 3 at the front and rear respectively. The upper end of the first scissor-type hinge component 3 located at the foremost side is hinged to the front frame 100, and the lower end of the first scissor-type hinge component 3 located at the foremost side is hinged to the first slider 4 slidably connected to the front frame 100. The upper end of the first scissor-type hinge component 3 located at the rearmost side is hinged to the rear frame 200, and the lower end of the first scissor-type hinge component 3 located at the rearmost side is hinged to the second slider 5 slidably connected to the rear frame 200. In addition, the upper end of the first scissor-type hinge component 3 located at the foremost side bends and extends rightward to form the first bending section 31, and the right end of the first bending section 31 is hinged to the upper right side of the front frame 100. The upper end of the first scissor-type hinge component 3 located at the rearmost side bends and extends rightward to form another first bending section 31, and the right end of the first bending section 31 is hinged to the upper right side of the rear frame 200.

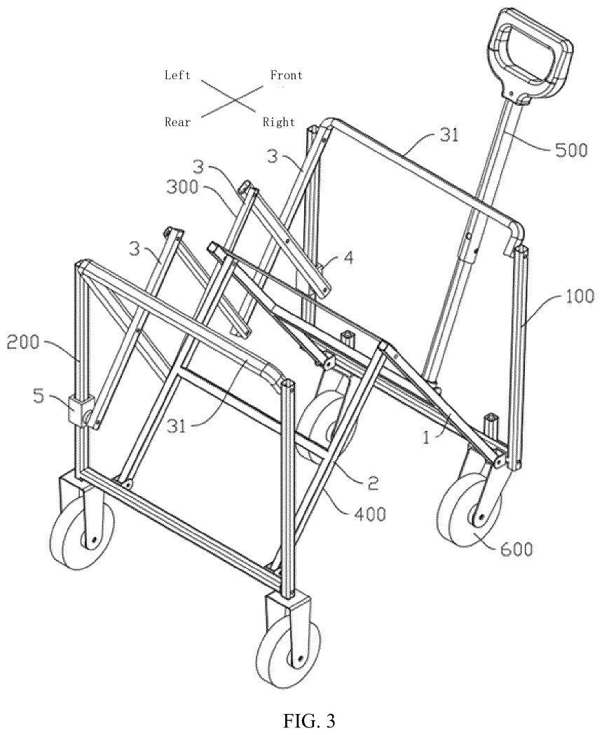

By only setting a single-side frame, the foldable cart in the present invention can not only receive items but also accommodate people. People can sit on the open side of the foldable cart and lean against the single-side frame 300, which improves the comfort and safety when they sit. In addition, the present invention also includes the tabletop board 700 placed on the front frame 100 and the rear frame 200. When the foldable cart is in an unfolded state, the tabletop board 700 can be placed on the front frame 100 and the rear frame 200. Moreover, even after the tabletop board 700 is placed on the front frame 100 and the rear frame 200, it is still possible to take items from the open side of the foldable cart, which is convenient to use. As shown in FIG. 3, when folding is required, the tabletop board 700 is removed, the bottom frame 400 is folded upward, the joint between the first frame 1 and the second frame 2 arches upward, the front frame 100 and the rear frame 200 approach each other, and the single-side frame 300 is folded simultaneously.

### Embodiment 2

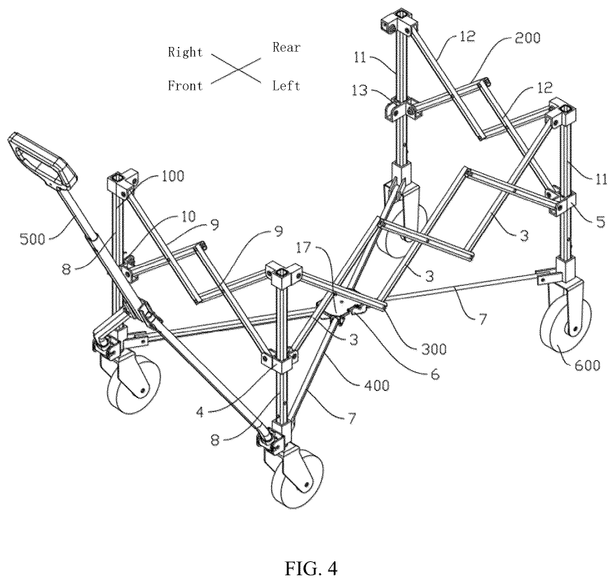

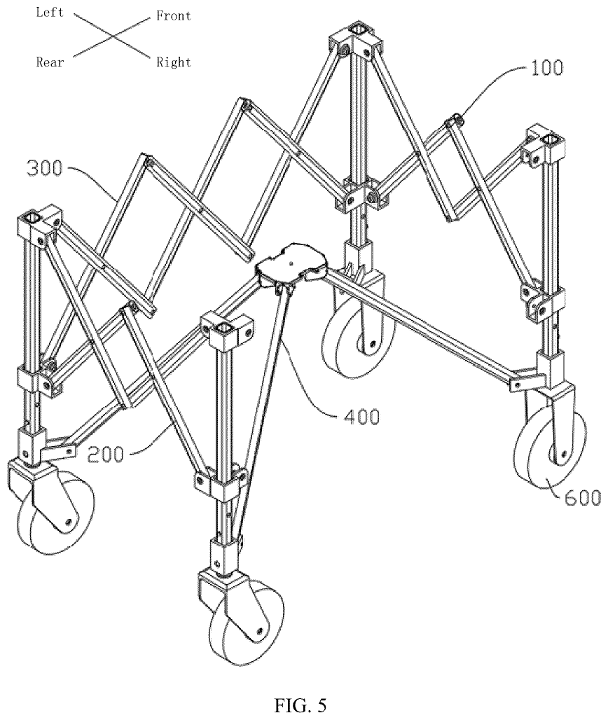

As shown in FIGS. 4 to 5, this embodiment provides another single-side open foldable cart frame. The difference between this embodiment and Embodiment 1 lies in that the bottom frame 400 includes the connecting block 6 and four first connecting rods 7. The projection of the connecting block 6 on the horizontal plane falls at the center of the bottom frame 400. One end of each of the four first connecting rods 7 is hinged to the connecting block 6, and the other ends of the four first connecting rods 7 are obliquely arranged and respectively hinged to the left and right sides of the bottom end of the front frame 100 and the left and right sides of the bottom end of the rear frame 200. Both the front frame 100 and the rear frame 200 are foldable structures that are foldable along the left-right direction. The limit mechanism includes a baffle 17 connected to the upper end surface of the connecting block 6. When the foldable cart frame is in an unfolded state, the upper end surface of one end of each first connecting rod 7 abuts against the baffle 17, such that one end of each first connecting rod 7 cannot rotate downward. When folding is required, one end of each first connecting rod 7 rotates upward.

As shown in FIG. 4, the front frame 100 includes two first uprights 8 and a plurality of second scissor-type hinge components 9. The plurality of second scissor-type hinge components 9 are hinged to each other successively from left to right. In this embodiment, there are two second scissor-type hinge components 9. The upper end of the second scissor-type hinge component 9 located at the leftmost side is hinged to the first upright 8 on the left, and the lower end of the second scissor-type hinge component 9 located at the leftmost side is hinged to the first slider 4 slidably connected to the first upright 8 on the left. The upper end of the second scissor-type hinge component 9 located at the rightmost side is hinged to the first upright 8 on the right, and the lower end of the second scissor-type hinge component 9 located at the rightmost side is hinged to the third slider 10 slidably connected to the first upright 8 on the right. The rear frame 200 includes two second uprights 11 and a plurality of third scissor-type hinge components 12. The plurality of third scissor-type hinge components 12 are hinged to each other successively from left to right. In this embodiment, there are two third scissor-type hinge components 12. The upper end of the third scissor-type hinge component 12 located at the leftmost side is hinged to the second upright 11 on the left, and the lower end of the third scissor-type hinge component 12 located at the leftmost side is hinged to the second slider 5 slidably connected to the second upright 11 on the left. The upper end of the third scissor-type hinge component 12 located at the rightmost side is hinged to the second upright 11 on the right, and the lower end of the third scissor-type hinge component 12 located at the rightmost side is hinged to the fourth slider 13 slidably connected to the second upright 11 on the right. The four first connecting rods 7 are respectively hinged to the lower ends of the two first uprights 8 and the lower ends of the two second uprights 11.

As shown in FIG. 5, during folding, the connecting block 6 is lifted upward, and the four first connecting rods 7 rotate and simultaneously drive the front frame 100, the rear frame 200 and the single-side frame 300 to fold.

### Embodiment 3

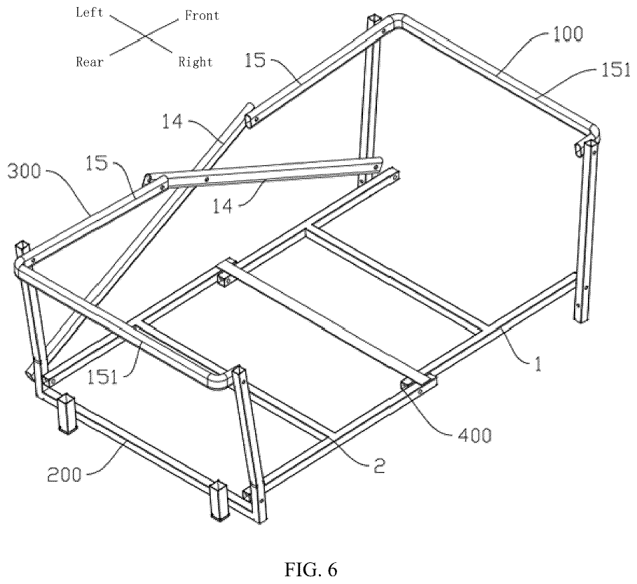

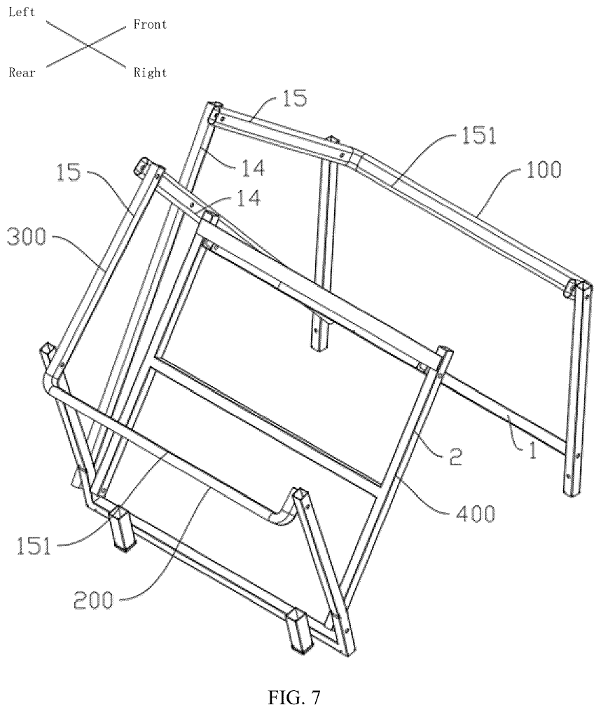

As shown in FIGS. 6 to 7, this embodiment provides another single-side open foldable cart frame. The difference between this embodiment and Embodiment 1 lies in that the single-side frame 300 includes two second connecting rods 14 and two third connecting rods 15. The two second connecting rods 14 are crossed and hinged to each other, and the hinge point of the two second connecting rods 14 is located at a position slightly above the middle of the second connecting rod 14. One end of one of the third connecting rods 15 is hinged to the upper end, adjacent to the front frame 100, of the second connecting rod 14 among the two second connecting rods 14, the other end of one of the third connecting rods 15 is hinged to the front frame 100 and bends and extends rightward to form the second bending section 151, and the right end of the second bending section 151 is hinged to the upper right end of the front frame 100. One end of the other third connecting rod 15 is hinged to the upper end, adjacent to the rear frame 200, of the second connecting rod 14 among the two second connecting rods 14, the other end of the other third connecting rod 15 is hinged to the rear frame 200 and bends and extends rightward to form another second bending section 151, and the right end of the second bending section 151 is hinged to the upper right end of the rear frame 200.

As shown in FIG. 7, during folding, the bottom frame 400 is folded upward, the joint between the first frame 1 and the second frame 2 arches upward, the front frame 100 and the rear frame 200 approach each other, and the single-side frame 300 is folded simultaneously.

The above is a detailed description of the embodiments of the present invention in conjunction with the drawings. However, the present invention is not limited to the above three embodiments. All other embodiments obtained by those skilled in the art without creative efforts shall fall within the scope of protection of the present invention.

What is claimed is:

1. A single-side open foldable cart frame, comprising a front frame, a rear frame, a single-side frame and a bottom frame; wherein the front frame and the rear frame are respectively connected to front and rear sides of the bottom frame; front and rear sides of the single-side frame are respectively connected to a left side of the front frame and a left side of the rear frame; both the bottom frame and the single-side frame are foldable structures that are interconnected; and a limit mechanism for keeping the foldable cart frame in an unfolded state when the foldable cart frame is unfolded is provided on the bottom frame.

2. The single-side open foldable cart frame according to claim 1, wherein the bottom frame comprises a first frame and a second frame; a first end of the first frame is hinged to a bottom end of the front frame, a second end of the first frame is hinged to a first end of the second frame, and a second end of the second frame is hinged to a bottom end of the rear frame;
the limit mechanism comprises a stop strip provided on the second end of the first frame; when the foldable cart frame is in the unfolded state, the stop strip abuts against an upper side of the first end of the second frame, wherein the first end of the second frame and the second end of the first frame do not rotate downward; and when folding is required, the second end of the first frame and the first end of the second frame rotate upward.

3. The single-side open foldable cart frame according to claim 1, wherein the single-side frame comprises a plurality of first scissor-type hinge components; the plurality of first scissor-type hinge components are hinged to each other successively from front to back;
an upper end of the first scissor-type hinge component located at a foremost side is hinged to the front frame, and a lower end of the first scissor-type hinge component located at the foremost side is hinged to a first slider slidably connected to the front frame; and
an upper end of the first scissor-type hinge component located at a rearmost side is hinged to the rear frame, and a lower end of the first scissor-type hinge component located at the rearmost side is hinged to a second slider slidably connected to the rear frame.

4. The single-side open foldable cart frame according to claim 3, wherein the upper end of the first scissor-type hinge component located at the foremost side and the upper end of the first scissor-type hinge component located at the rearmost side respectively form first bending sections, and the first bending sections are respectively hinged to an upper right side of the front frame and an upper right side of the rear frame.

5. The single-side open foldable cart frame according to claim 1, wherein the bottom frame comprises a connecting block and four first connecting rods; a projection of the connecting block on a horizontal plane falls at a center of the bottom frame; a first end of each of the four first connecting rods is hinged to the connecting block, and second ends of the four first connecting rods are obliquely arranged and respectively hinged to left and right sides of a bottom end of the front frame and left and right sides of a bottom end of the rear frame;
both the front frame and the rear frame are foldable structures that are foldable along a left-right direction; the limit mechanism comprises a baffle connected to an upper end surface of the connecting block; when the foldable cart frame is in the unfolded state, an upper end surface of the first end of each of the four first connecting rods abuts against the baffle, wherein the first end of each of the four first connecting rods do not rotate downward; and when folding is required, the first end of each of the four first connecting rods rotates upward.

6. The single-side open foldable cart frame according to claim 5, wherein the front frame comprises two first uprights and a plurality of second scissor-type hinge components; the plurality of second scissor-type hinge components are hinged to each other successively from left to right;
an upper end of the second scissor-type hinge component located at a leftmost side is hinged to the first upright on left, and a lower end of the second scissor-type hinge component located at the leftmost side is hinged to a first slider slidably connected to the first upright on the left; an upper end of the second scissor-type hinge component located at a rightmost side is hinged to the first upright on right, and a lower end of the second scissor-type hinge component located at the rightmost side is hinged to a third slider slidably connected to the first upright on the right;
the rear frame comprises two second uprights and a plurality of third scissor-type hinge components; the plurality of third scissor-type hinge components are hinged to each other successively from left to right; an upper end of the third scissor-type hinge component located at the leftmost side is hinged to the second upright on the left, and a lower end of the third scissor-type hinge component located at the leftmost side is hinged to a second slider slidably connected to the second upright on the left; and
an upper end of the third scissor-type hinge component located at the rightmost side is hinged to the second upright on the right, and a lower end of the third scissor-type hinge component located at the rightmost side is hinged to a fourth slider slidably connected to the second upright on the right.

7. The single-side open foldable cart frame according to claim 1, wherein the single-side frame comprises two second connecting rods and two third connecting rods; the two second connecting rods are crossed and hinged to each other;
a first end of a first one of the two third connecting rods is hinged to an upper end, adjacent to the front frame, of the second connecting rod among the two second connecting rods, and a second end of the first one of the two third connecting rods is hinged to the front frame; and
a first end of a second one of the two third connecting rods is hinged to an upper end, adjacent to the rear frame, of the second connecting rod among the two second connecting rods, and a second end of the second one of the two third connecting rods is hinged to the rear frame.

8. The single-side open foldable cart frame according to claim 7, wherein the second ends of the two third connecting rods respectively bend and extend rightward to form second bending sections, and the second bending sections are respectively hinged to an upper right end of the front frame and an upper right end of the rear frame.

9. The single-side open foldable cart frame according to claim 1, further comprising a tabletop board placed on the front frame and the rear frame.

10. The single-side open foldable cart frame according to claim 1, wherein a push-pull rod is hinged to the front frame; and wheels are connected to bottom ends of both the front frame and the rear frame.

11. The single-side open foldable cart frame according to claim 2, wherein the single-side frame comprises a plurality of first scissor-type hinge components; the plurality of first scissor-type hinge components are hinged to each other successively from front to back;
an upper end of the first scissor-type hinge component located at a foremost side is hinged to the front frame, and a lower end of the first scissor-type hinge component located at the foremost side is hinged to a first slider slidably connected to the front frame; and
an upper end of the first scissor-type hinge component located at a rearmost side is hinged to the rear frame, and a lower end of the first scissor-type hinge component located at the rearmost side is hinged to a second slider slidably connected to the rear frame.

12. The single-side open foldable cart frame according to claim 11, wherein the upper end of the first scissor-type hinge component located at the foremost side and the upper end of the first scissor-type hinge component located at the rearmost side respectively form first bending sections, and the first bending sections are respectively hinged to an upper right side of the front frame and an upper right side of the rear frame.

13. The single-side open foldable cart frame according to claim 2, wherein the single-side frame comprises two second connecting rods and two third connecting rods; the two second connecting rods are crossed and hinged to each other;
a first end of a first one of the two third connecting rods is hinged to an upper end, adjacent to the front frame, of the second connecting rod among the two second connecting rods, and a second end of the first one of the two third connecting rods is hinged to the front frame; and
a first end of a second one of the two third connecting rods is hinged to an upper end, adjacent to the rear frame, of the second connecting rod among the two second connecting rods, and a second end of the second one of the two third connecting rods is hinged to the rear frame.

14. The single-side open foldable cart frame according to claim 13, wherein the second ends of the two third connecting rods respectively bend and extend rightward to form second bending sections, and the second bending sections are respectively hinged to an upper right end of the front frame and an upper right end of the rear frame.
